(19) United States
(12) Patent Application Publication
(10) Pub. No.: US 2021/0331678 A1
(43) Pub. Date: Oct. 28, 2021

(54) METHOD OF PROVIDING VEHICLE REFUGE INFORMATION IN DISASTER SITUATION AND APPARATUS THEREFOR

(71) Applicant: LG Electronics Inc., Seoul (KR)

(72) Inventor: Nayoung YI, Seoul (KR)

(21) Appl. No.: 16/487,065

(22) PCT Filed: Jul. 12, 2019
(86) PCT No.: PCT/KR2019/008625

§ 371 Date: Aug. 19, 2019

(51) Int. Cl. B60W 40/02; B60W 40/08; H04W 4/02; H04W 4/40; H04W 4/90; H04W 72/04

(52) U.S. Cl. CPC B60W 40/02; B60W 40/08; H04W 4/025; B60W 2556/50; H04W 4/90; H04W 72/042; B60W 2555/20; H04W 4/40

(57) ABSTRACT

A method of providing disaster refuge information for an autonomous vehicle and an intelligent device controlling a server. A processor of the vehicle may enable location information of the vehicle to be transmitted to a first server and enable refuge information to be received from the first server. The refuge information may be generated by the first server based on first disaster-related information related to a special weather report, second disaster-related information including shelter-related information, and the location information. The refuge information may include at least one of shelter guidance information, vehicle control information or route resetting information. One or more of the autonomous vehicle, user terminal and server may be associated with an artificial intelligence module, a drone (unmanned aerial vehicle (UAV)), a robot, an augmented reality (AR) device, a virtual reality (VR) device, or a device related to 5G service.

### TECHNICAL FIELD

The present invention relates to a method of providing vehicle refuge information in a disaster situation and an apparatus therefor and, more particularly, to a method of providing a vehicle or a vehicle passenger with vehicle refuge information in a disaster situation, for refuge from a disaster situation, and an apparatus therefor.

### BACKGROUND ART

Vehicles can be classified into an internal combustion engine vehicle, an external composition engine vehicle, a gas turbine vehicle, an electric vehicle, etc. according to types of motors used therefor.

Recently, the development of a system for the safety or rapid refuge of a vehicle passenger in a disaster situation is actively performed. In the system for refuge from a disaster situation, a server functions to receive, from a weather center server or a public data portal, information for a vehicle passenger's refuge from a disaster situation and to provide the information to the vehicle passenger.

In a disaster situation, to automatically provide a disaster situation and information for refuge from a disaster situation without a separate search procedure by a vehicle passenger is problematic.

### DISCLOSURE

### Technical Problem

The present invention has been made to solve the above needs and/or problem.

Furthermore, the present invention is to implement a method for providing a refuge method to a vehicle passenger in a disaster situation.

Furthermore, the present invention is to implement a method for automatically notifying a vehicle passenger of a shelter in a disaster situation.

Furthermore, the present invention is to implement a method for making different shelter route guidance based on the type of special weather report with respect to a vehicle passenger in a disaster situation.

Furthermore, the present invention is to implement a method for automatically notifying a vehicle passenger of a refuge route in a disaster situation.

Furthermore, the present invention is to implement a method for notifying a vehicle passenger of visual information related to the current (real-time) progress of a disaster situation in the disaster situation.

Technical objects to be achieved in the present invention are not limited to the above-described technical objects, and other technical objects not described above may be evidently understood by a person having ordinary skill in the art to which the present invention pertains from the following description.

### Technical Solution

A method of providing disaster refuge information for an autonomous vehicle according to an embodiment of the present invention includes receiving location information from an autonomous vehicle, receiving, from a first server, first disaster-related information related to a special weather report, receiving, from a second server, second disaster-related information including shelter-related information, generating refuge information based on the first disaster-related information, the second disaster-related information, and the location information, and transmitting the refuge information to the autonomous vehicle. The refuge information includes at least one of shelter guidance information, vehicle control information or route resetting information.

Generating refuge information may include determining whether the engine of the autonomous vehicle is turned on and performing one of a first determination procedure or a second determination procedure depending on whether the engine of the autonomous vehicle is turned on.

The first determination procedure is performed if the engine of the autonomous vehicle is turned on. The first determination procedure may include determining whether the first disaster-related information has a relevance to a moving route of the autonomous vehicle, determining whether shelter guidance is necessary based on the first disaster-related information, and determining whether the autonomous vehicle now belongs to a disaster alert area based on the location information.

The second determination procedure is performed if the engine of the autonomous vehicle is not turned on. The second determination procedure may include determining whether the first disaster-related information is valid at timing in which the engine of the autonomous vehicle is turned on.

The autonomous vehicle is equipped with a navigator. A screen of the navigator may display a common screen of the navigator related to route guidance if the first disaster-related information is not valid at the timing in which the engine of the autonomous vehicle is turned on.

If the first disaster-related information is valid at the timing in which the engine of the autonomous vehicle is turned on, the second determination procedure may further include determining whether the first disaster-related information has a relevance to the moving route of the autonomous vehicle, determining whether shelter guidance is necessary based on the first disaster-related information, and determining whether the autonomous vehicle now belongs to the disaster alert area based on the location information.

The first disaster-related information may be special weather report issue information.

The second disaster-related information may include at least one of shelter information, disaster area CCTV information or disaster danger district information.

The method further includes providing additional disaster-related information to the autonomous vehicle based on the first disaster-related information. Whether to provide the additional disaster-related information may be determined based of a choice of a passenger of the autonomous vehicle.

The location information may be transmitted periodically by the autonomous vehicle.

Receiving first disaster-related information may include requesting, from the first server, the first disaster-related information necessary to provide specific disaster information to the vehicle and receiving the first disaster-related information from the first server if a special weather report is issued.

Receiving first disaster-related information may include periodically requesting the first disaster-related information from the first server and receiving the first disaster-related information from the first server if a special weather report is issued.

Receiving second disaster-related information may include requesting the second disaster-related information from the second server and receiving the second disaster-related information from the second server.

The autonomous vehicle includes a navigator. At least one of the shelter guidance information, the vehicle control information or the route resetting information may be visualized and displayed on a partial screen of the navigator.

The autonomous vehicle includes a navigator. At least one of the shelter guidance information, the vehicle control information or the route resetting information may be visualized and displayed on the entire screen of the navigator.

The method further includes transmitting, to the autonomous vehicle, downlink control information (DCI) used to schedule the transmission of the refuge information. The refuge information may be transmitted to the autonomous vehicle based on the DCI.

The method further includes performing an initial access procedure with the autonomous vehicle based on a synchronization signal block (SSB). The refuge information may be transmitted to the autonomous vehicle through a physical downlink shared channel (PDSCH). The SSB and the dedicated demodulation-reference signal (DM-RS) of the PDSCH may be QCLed with respect to a quasi co-location (QCL) type D.

Furthermore, an intelligent computing device controlling an autonomous vehicle according to another aspect of the present invention includes a wireless communication unit, a location information acquisition unit, a processor, and a memory including a command executable by the processor. The command enables location information of the vehicle to be transmitted to a first server through the wireless communication unit and enables refuge information to be received from the first server. The refuge information is generated by the first server based on first disaster-related information related to a special weather report, second disaster-related information including shelter-related information, and the location information. The refuge information includes at least one of shelter guidance information, vehicle control information or route resetting information.

### Advantageous Effects

The present invention has an effect in that it can provide a refuge method to a vehicle passenger in a disaster situation.

Furthermore, according to the present invention, a vehicle passenger can be automatically notified of a refuge method and a shelter.

Furthermore, according to the present invention, shelter route guidance for a vehicle passenger can be made different based on the type of special weather report.

Furthermore, according to the present invention, a vehicle passenger can be automatically notified of a refuge route in a disaster situation.

Furthermore, according to the present invention, a real-time disaster situation can be visually provided to a vehicle passenger in a disaster situation.

Effects which may be obtained in the present invention are not limited to the above-described effects, and other technical effects not described above may be evidently understood by a person having ordinary skill in the art to which the present invention pertains from the following description.

### DESCRIPTION OF DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram illustrating the interior of a vehicle according to an embodiment of the present invention.

FIG. 10 is a block diagram referred to in description of a cabin system for a vehicle according to an embodiment of the present invention.

FIG. 11 is a diagram referred to in description of a usage scenario of a user according to an embodiment of the present invention.

FIG. 12 is a diagram for illustrating a system in which a method of providing vehicle refuge information in a disaster situation according to an embodiment of the present invention is performed.

FIG. 13 is a flowchart of a method of providing disaster refuge information for an autonomous vehicle according to an embodiment of the present invention.

FIG. 14 is a flowchart of a method of providing disaster refuge information for an autonomous vehicle according to an embodiment of the present invention.

FIG. 15 is a flowchart of a method of providing disaster refuge information for an autonomous vehicle according to an embodiment of the present invention.

FIG. 16 is a flowchart of a system in which a method of providing vehicle refuge information in a disaster situation according to an embodiment of the present invention is performed.

FIG. 17 is a diagram showing an example of a navigator screen provided in a vehicle in a method of providing disaster refuge information for an autonomous vehicle according to an embodiment of the present invention.

FIG. 18 is a diagram showing another example of a navigator screen provided in a vehicle in a method of providing disaster refuge information for an autonomous vehicle according to an embodiment of the present invention.

FIG. 19 is a diagram showing another example of a navigator screen provided in a vehicle in a method of providing disaster refuge information for an autonomous vehicle according to an embodiment of the present invention.

FIG. 20 is a flowchart of a method of providing disaster refuge information for an autonomous vehicle according to an embodiment of the present invention.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

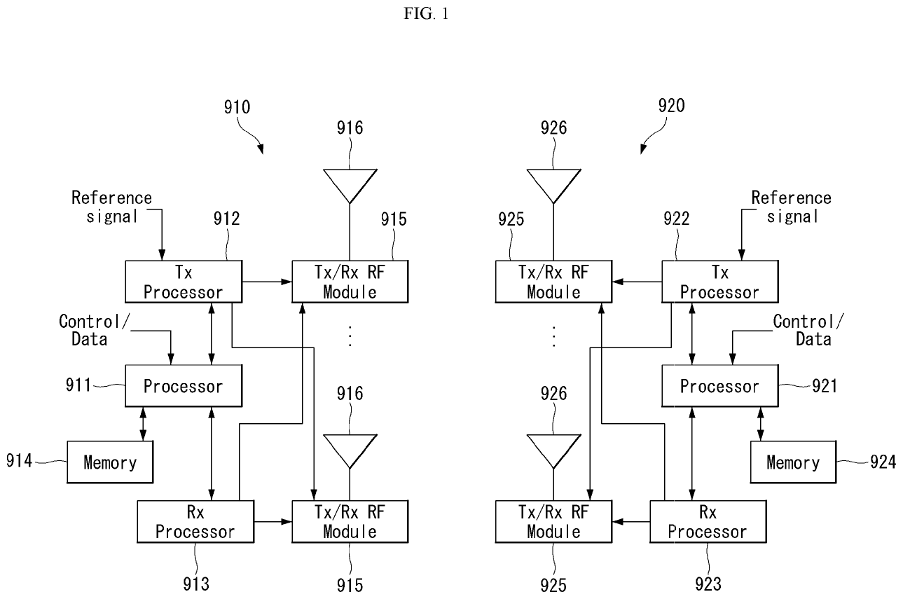

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

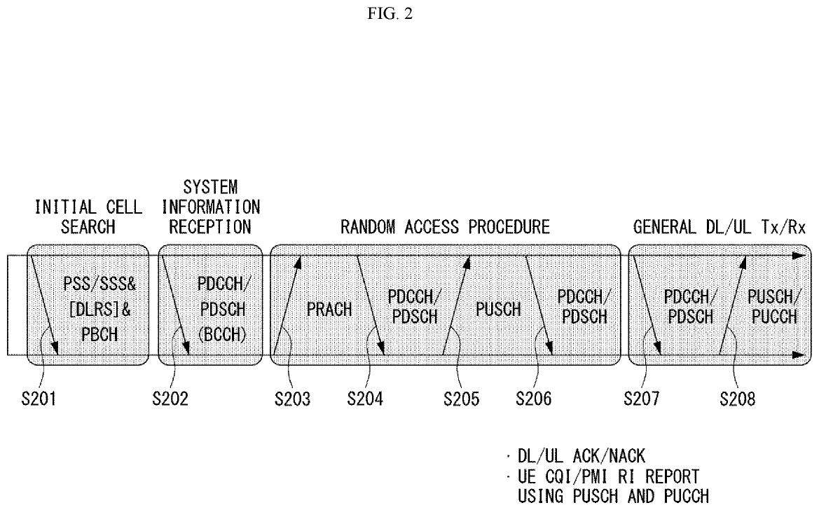

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs.

In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

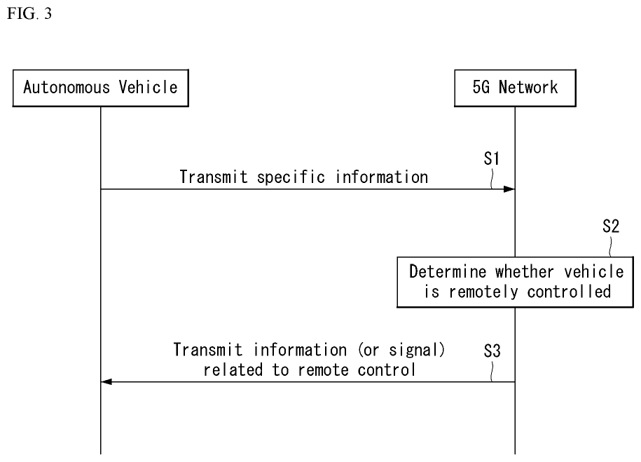

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. Abeam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

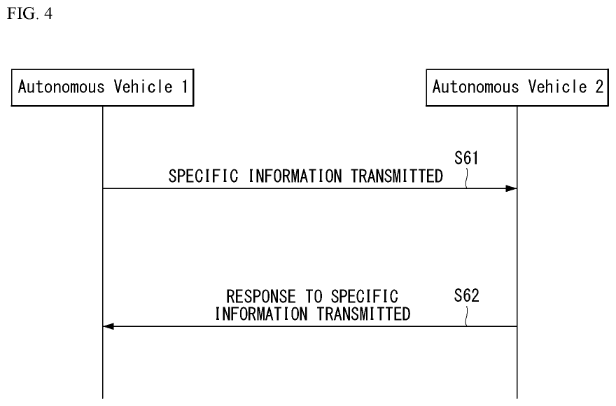

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

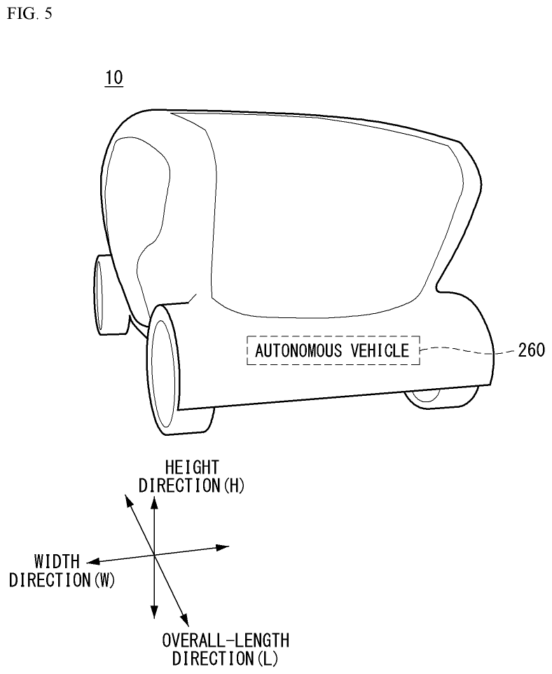

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

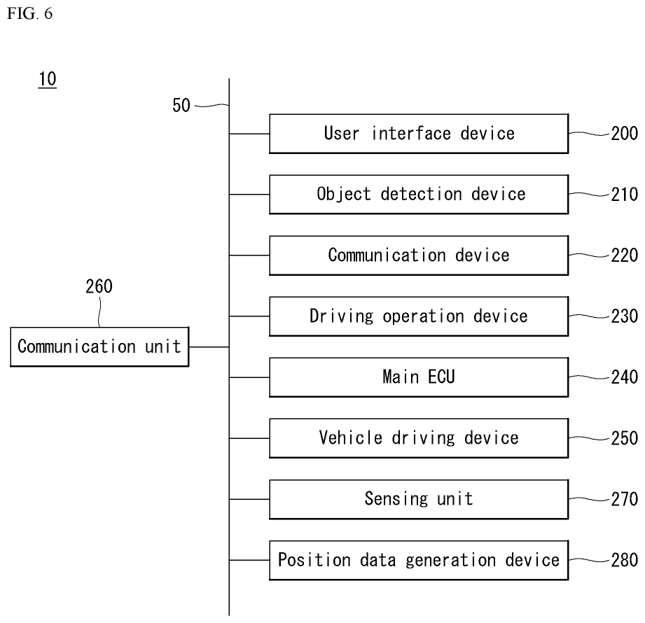

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object detection device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate.

The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

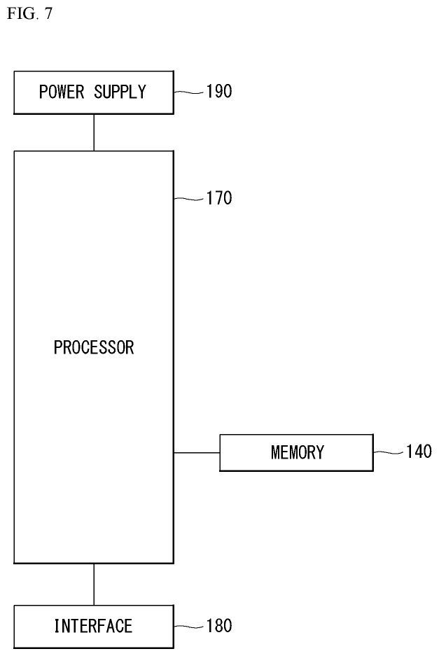

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

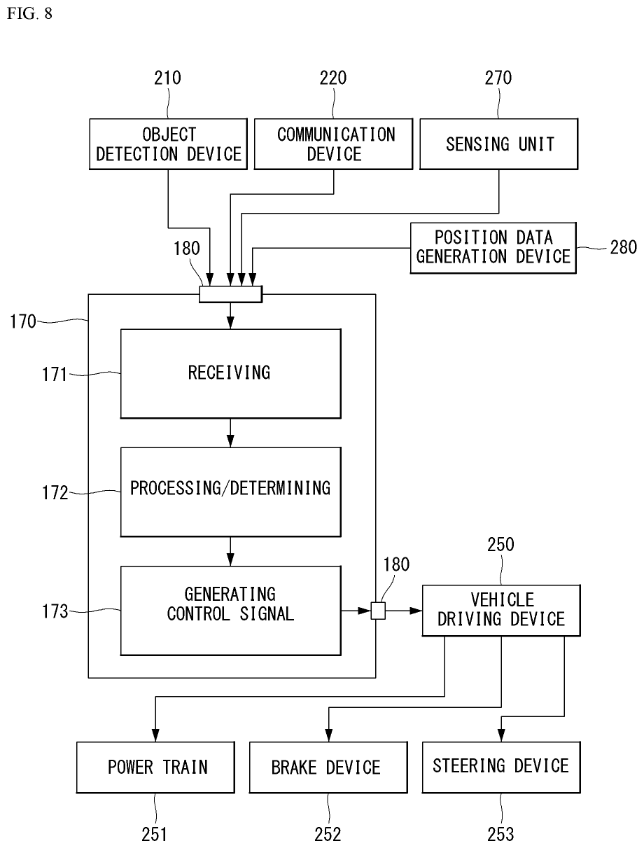

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

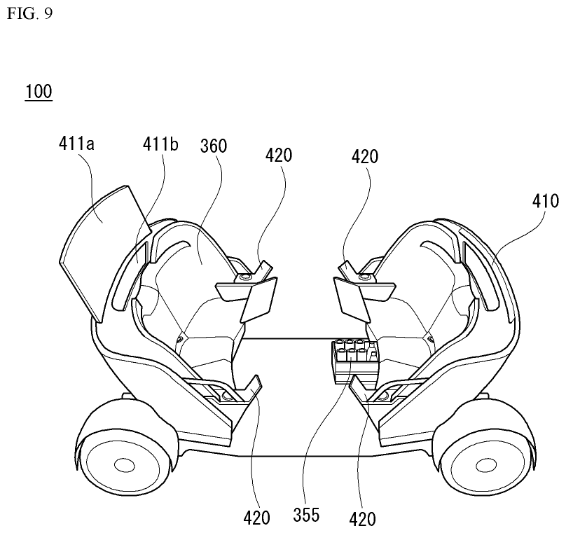

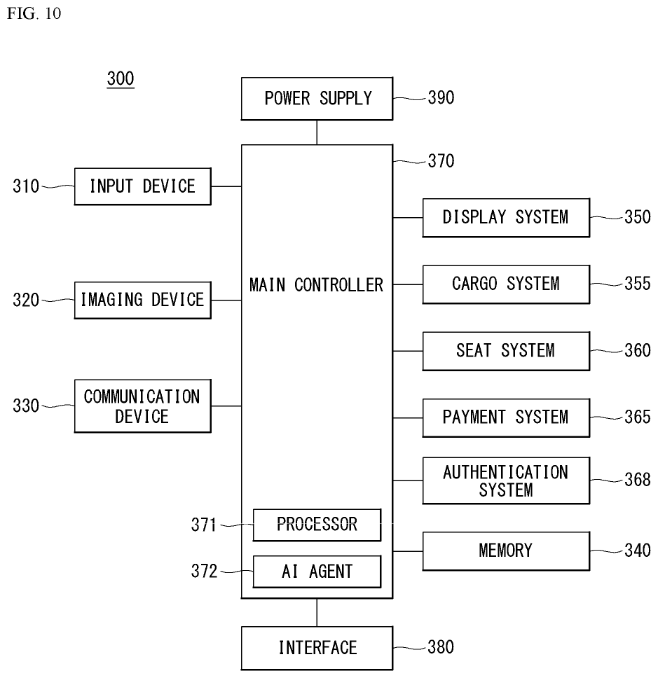

FIG. 9 is a diagram showing the interior of the vehicle according to an embodiment of the present invention. FIG. 10 is a block diagram referred to in description of a cabin system for a vehicle according to an embodiment of the present invention.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

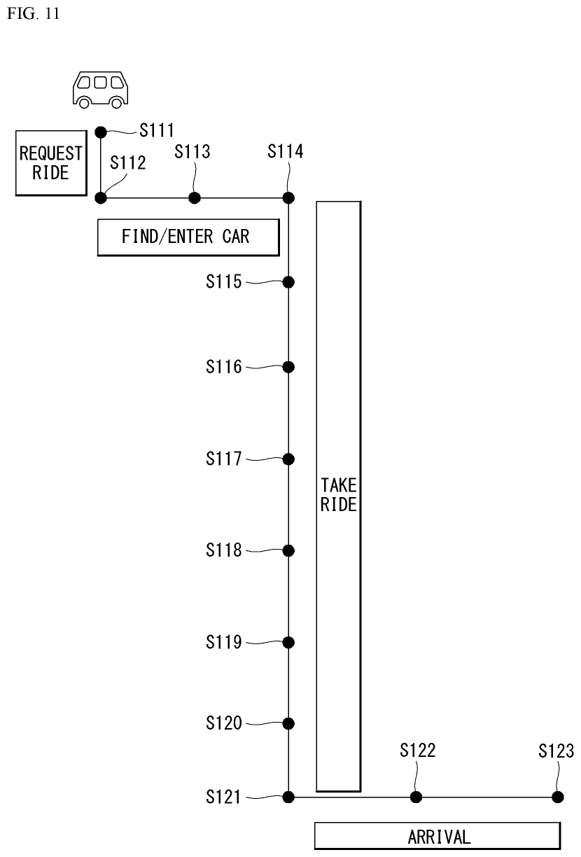

FIG. 11 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present invention which will be described later and applied or can complement the methods proposed in the present invention to make technical features of the present invention concrete and clear.

Hereinafter, various embodiments of the present invention will be described in detail with reference to the attached drawings.

The present invention provides a method of providing information that helps a vehicle in which a passenger rides (or a vehicle passenger) to safely take refuge from a disaster situation (hereinafter referred to as “refuge information”) when a disaster situation which may be applied to the above-described system or scenario occurs.

In the existing method of providing refuge information to a vehicle in which a passenger rides in a disaster situation (or an emergency situation), when a disaster occurs, the vehicle cannot be automatically provided with information including information related to a shelter. That is, the passenger in the vehicle has to directly search for/input refuge information, such as a shelter. Accordingly, the existing method has a problem in that a refuge information search/input time is taken for a passenger to directly obtain refuge information.

Furthermore, there are problems in that a passenger cannot be aware of a current disaster situation until he or she directly searches for/inputs refuge information and it is difficult for the passenger to recognize and determine a refuge method and a refuge route.

In order to solve the problems of the existing method, the present invention provides a method of automatically providing, by a central server functioning to provide refuge information, a vehicle passenger (or vehicle) with refuge information although the vehicle passenger does not directly perform search/discovery for refuge information including information, such as a shelter.

A method provided in this specification has an effect in that a search/determination time taken for a vehicle passenger's in an emergency situation is reduced because the passenger can be automatically aware of a refuge route in a disaster situation.

Furthermore, a method provided in this specification has an effect in that a vehicle passenger can be helped to recognize a current situation because the vehicle passenger can be aware of visual information related to the progress of a disaster situation in real time in the disaster situation.

A method provided in this specification is described specifically below.

Hereinafter, a “vehicle” may mean all of a “vehicle in which a passenger rides” or a “vehicle passenger”, and may be an autonomous vehicle. Hereinafter, a “vehicle” is represented in brief, for convenience of description.

Furthermore, hereinafter, a “vehicle” may be a driving vehicle or may be a parked vehicle or may be a vehicle whose engine has been turned off for driving after a parking state.

Furthermore, a server that provides refuge information to a vehicle is called a “server.” The server may be an “OEM server.”

Hereinafter, the OEM server is represented as a “server”, for convenience of description.

Furthermore, hereinafter, A and/or B means at least one of A and B.

A system in which a method of providing vehicle refuge information in a disaster situation is performed is called a passenger refuge guidance system in a disaster situation.

The passenger refuge guidance system enables a shelter location to be displayed in a navigator included in a vehicle and disaster information to be displayed in the navigator when a special weather report is issued, and enables a vehicle passenger to start route search/guidance when he or she selects a required shelter.

Furthermore, the refuge guidance system enables a shelter location to be displayed on the first screen of a navigator included in a vehicle as soon as a vehicle passenger starts the engine of a parked vehicle. In contrast, the refuge guidance system enables a common screen of the navigator related to route guidance to be displayed when the engine of the vehicle is turned on after the issue of a special report is released.

Furthermore, the refuge guidance system makes different a shelter guidance route based on an issued special weather report, and enables information on a disaster situation to be forwarded in a text/media form during driving.

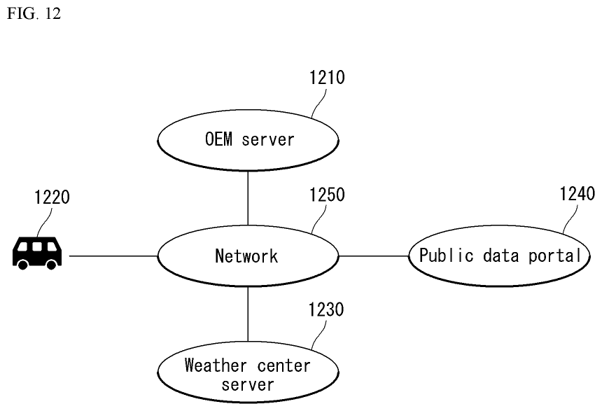

FIG. 12 is a diagram showing an example of a passenger refuge guidance system in a disaster situation.

The passenger refuge guidance system in a disaster situation may include a server 1210, a weather center server 1230, a public data portal 1240, and a vehicle 1220.

An operation of the server 1210, the vehicle 1220, the weather center server 1230, and the public data portal 1240 within the passenger refuge guidance system in a disaster situation is described in brief below.

First, the server 1210 may receive specific information related to a disaster situation from each of the vehicle 1220, the weather center server 1230, and the public data portal 1240.

Furthermore, the weather center server 1230 may receive a request for specific information related to a disaster situation from the server 1210, and may transmit the specific information related to the disaster situation to the server 1210.

Furthermore, the public data portal 1240 may receive a request for specific information related to a disaster situation from the server 1210, and may transmit the specific information related to the disaster situation to the server 1210.

Finally, the vehicle 1220 may transmit its own location information to the server 1210, and may receive vehicle refuge information from the server 1210. The received refuge information may be visualized through a navigator included in the vehicle 1220, and may be displayed.

Hereinafter, the weather center server is represented as a “first server”, for convenience of description. The public data portal 1240 is represented as a “second server.”

Hereinafter, in the operation of the server 1210, the vehicle 1220, the weather center server 1230, and the public data portal 1240, operations performed in the server 1210 are described more specifically.

The operations performed in the server are chiefly described for convenience of description, but they are merely embodiments and the contents of the present invention are not limited to only the operations of the server.

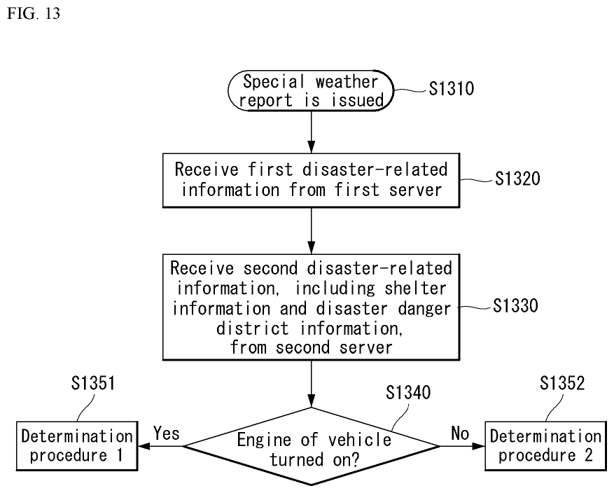

Hereinafter, a method of providing disaster refuge information for an autonomous vehicle is described more specifically with reference to FIGS. 13 to 15.

FIG. 13 is a flowchart of a method of providing disaster refuge information for an autonomous vehicle according to an embodiment of the present invention.

Although not shown in FIG. 13, the server receives location information from the vehicle. Furthermore, the location information may be periodically transmitted to the server.

The location information may be GPS information of the vehicle. Furthermore, in addition to the GPS information, a variety of pieces of information that may notify the server of the location of the vehicle may be included in the location information.

Furthermore, the reception period of the location information may be different based on a current situation. Specifically, the reception period may be shorter in the situation in which the server has to identify the location of the vehicle more precisely.

For example, the server may identify the location of the vehicle accurately by receiving location information of the vehicle in a short period in a disaster situation.

In contrast, the server may receive location information of the vehicle in a long period in a non-disaster situation.

As described above, the server may identify the location of the vehicle that varies in real time as the vehicle moves.

Furthermore, the reception period of location information may be different based on a current situation. There is an effect in that traffic of location information received from a vehicle can be managed efficiently.

The location information of the vehicle may be used by the server in order to generate refuge information provided to the vehicle.

Next, when a special weather report is issued (S1310), the server receives first disaster-related information from the first server (S1320). The disaster-related information may be special weather report issue information. Furthermore, the first server may be the weather center server.

The first disaster-related information may include special weather report issue information for various disaster situations.

For example, the first disaster-related information may be information on a tsunami occurrence situation. Furthermore, the first disaster-related information may be information on a flood occurrence situation and may be information on a typhoon occurrence situation. The first disaster-related information may be information on an earthquake occurrence situation or may be information on a heavy snow occurrence situation or may be information on a forest fire occurrence situation or may be information on a yellow dust/fine dust occurrence situation.

The above-described examples are merely examples, and the present invention is not limited thereto. That is, it is evident that the present invention may be applied to various disaster situations in addition to the disaster situations.

An operation of receiving, by the server, information related to a special weather report from the first server includes the following two steps.

The server requests the first disaster-related information from the first server.

Next, the server receives the first disaster-related information from the first server.

The above operation may be performed through two methods of a publish (Pub)/subscribe (Sub) method or a representational state transfer (REST) application program interface (API) method.

In the publish (Pub)/subscribe (Sub) method, the server may subscribe to the first server for a topic for required special report information.

To subscribe to the topic for required special report information may mean that the server requests only special report information related to a required specific special weather report. The specific special weather report requested by the server may be determined by the vehicle.

More specifically, the vehicle may forward, to the server, a request for a specific special weather report determined to be necessary for driving through a communication unit within the vehicle. The server that has received the request may subscribe or request, from the first server, only special report information related to the requested specific special weather report.

Next, the server receives the first disaster-related information (alert information) of a corresponding topic, when a special report issue is issued, from the first server.

In the Pub/Sub method capable of subscribing or requesting a topic for required special report information, the driving ability or habit of a driver may be taken into consideration. For example, there may be a driver who is vulnerable to the driving ability in a snowy or rainy weather situation. In such a case, the driver may request, from the server, only special report information related to heavy snow or heavy rain. The server that has received the request may subscribe to only special report information related to heavy snow or heavy rain through the first server.

Furthermore, in the process of requesting, by the vehicle, only special report information related to a specific special weather report from the server, in preparation for a case where weather conditions were good before the start of driving, but weather conditions suddenly worsen during driving, a configuration may be performed so that the first disaster-related information is immediately provided to the vehicle if a specific special weather report is issued before the start of driving.

In the REST API method, the server periodically requests, from the first server, the first disaster-related information related to required special report information through an HTTP get method.

The request period of the first disaster-related information is not fixed and may be different. That is, the request period may be a long period or a short period.

There is an effect in that communication traffic for a request for the first disaster-related information can be managed efficiently because the request period of the first disaster-related information is differently set.

Thereafter, the server receives, from the first server, the first disaster-related information (alert information) transmitted through an HTTP response method when a special report is issued.

The first disaster-related information may be used for the server to generate refuge information provided to the vehicle.

Specifically, the server may transmit proper refuge information to the vehicle based on the type of disaster situation using the first disaster-related information.

Although the first disaster-related information is not received from the server, it is requested after a lapse of a given time because the first disaster-related information is requested periodically. Accordingly, the possibility that the vehicle does not receive the first disaster-related information from the server is reduced.

Furthermore, there is an effect in that a current weather situation can be checked accurately because the first disaster-related information is requested periodically and the first disaster-related information as a response to the request are received.

Next, the server receives second disaster-related information from the second server (S1330). The second server may be a public data portal.

The second disaster-related information may include a variety of pieces of information which may be usefully used in a disaster situation. For example, the second disaster-related information may be information on a shelter, CCTV information of a disaster area, or information, such as a disaster danger district (tsunami, collapse, flooding, or a steep slope-land).

The above examples are merely examples, and the present invention is not limited thereto. That is, it is evident that the second disaster-related information may include various pieces of disaster-related information in addition to the disaster-related information.

An operation of receiving, by the server, the second disaster-related information from the second server includes the following two steps.

First, the server requests second disaster-related information from the second server using an HTTP get method through an Open API.

The Open API means an open API through which an Internet user can directly develop an application program and services instead of being provided with the results of web search and a user interface (UI) one-sidedly. The Open API may be applied to a map service and various services and has an advantage in that it is accessible to everyone.

Next, the server receives second disaster-related information from the second server (S1330). The second disaster-related information may include information on a shelter, CCTV information of a disaster area, and a disaster danger district.

Furthermore, the second disaster-related information may be a JavaScript Object Notation (json)/eXtensible Markup Language (xml) format.

The second disaster-related information may be used for the server to generate refuge information provided to the vehicle.

Specifically, the server may transmit proper refuge information to the vehicle using the second disaster-related information.

Next, the server generates information necessary for the vehicle to take refuge from a disaster situation (hereinafter referred to as “refuge information”) transmitted to the vehicle, and determines whether the engine of the vehicle is turned on in order to transmit the generated refuge information to the vehicle (S1340).

The refuge information is generated based on at least one of the first disaster-related information, the second disaster-related information, and location information of the vehicle.

As described above, the first disaster-related information may include special weather report issue information for various disaster situations.

Furthermore, the second disaster-related information may include information on a shelter, CCTV information of a disaster area, and information, such as a disaster danger district (tsunami, collapse, flooding, or a steep slope-land).

A determination procedure 1 (S1351) may be performed or a determination procedure 2 (S1352) may be performed based on a result of S1340.

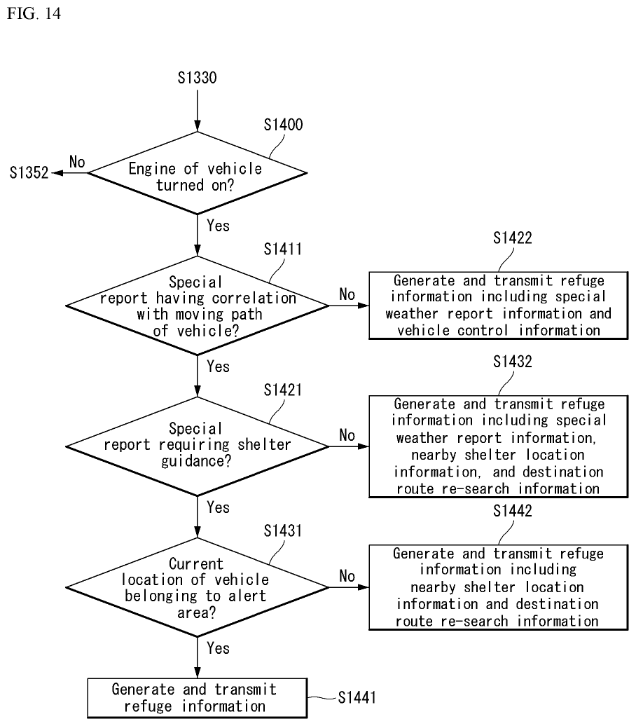

FIG. 14 is a flowchart of a method of providing disaster refuge information for an autonomous vehicle according to an embodiment of the present invention.

FIG. 14 shows a process of performed in the determination procedure 1 specifically.

The determination procedure 1 is performed if it is determined that the engine of the vehicle is turned on as a result of determining (S1400) whether the engine of the vehicle is turned on.

Next, the server determines whether the type of special report has a correlation with the route of the vehicle (S1411).

In this case, the server may determine whether the type of special report has a correlation with the route of the vehicle based on the type of disaster situation using the first disaster-related information.

The type of special weather report having a correlation with the moving route of a vehicle may include tsunami, flood, typhoon, an earthquake, heavy snow and a forest fire. Furthermore, the type of special weather report having a less correlation with the moving route of a vehicle may include yellow dust and fine dust.

The type of special weather report is merely an example, and the present invention is not limited to the examples. That is, the type of special weather report may include the type of special weather report having a correlation with the moving route of a vehicle and the type of special weather report having a less correlation with the moving route of a vehicle in addition to the above examples.

If the server determines that the type of special report has a less correlation with the moving route of the vehicle as a result of the determination of the correlation with the moving route of the vehicle, the server may generate refuge information and transmit the refuge information to the vehicle (S1422).

The refuge information may include special weather report information and vehicle control information.

The special weather report information may be displayed on a partial screen of a navigator included in the vehicle that has received the refuge information. For example, the existing destination route guidance may be displayed on a partial screen of the navigator, and special weather report information may be displayed on the remaining some screen.

The vehicle control information means information used to control the body of the vehicle based on the type of special report. For example, if the type of special report is yellow dust or fine dust, the window and sunroof of the vehicle may be automatically closed, and an indoor air purification function may be driven.

In contrast, if the server determines that the type of special report has a correlation with the moving route of the vehicle as result of the determination of the correlation with the moving route of the vehicle, the server determines whether the type of special report is a special report that requires shelter guidance (S1421).

In this case, the server may determine whether the type of special report is a special report that requires shelter guidance based on the type of disaster situation using the first disaster-related information.

For example, the type of special weather report that requires shelter guidance may include tsunami, flood, a typhoon and an earthquake. The type of special weather report that does not require shelter guidance may include heavy snow, a forest fire, yellow dust and fine dust.

The type of special weather report is merely an example, and the present invention is not limited to the examples. That is, the type of special weather report may further include the type of special weather report that requires shelter guidance and the type of special weather report that does not require shelter guidance in addition to the above examples.

If the server determines that the type of special report is a special report that does not require shelter guidance a result of the determination of whether the type of special report is a special report that requires shelter guidance, the server may generate refuge information and transmit the refuge information to the vehicle (S1432).

The refuge information may include special weather report information, nearby shelter location information, and destination route re-search information, that is, information on a re-searched route up to the existing destination of the vehicle.

In this case, the server may receive weather information from the first server. The server may transmit the special weather report information to the vehicle through the weather information.

The special weather report information may include information on a disaster occurrence date, a disaster location, and the distance from the vehicle to a disaster location.

Furthermore, the server may transmit the nearby shelter location information to the vehicle based on the second disaster-related information received from the second server, and may re-search for a route to the destination based on a route setting criterion differently set based on the type of special report.

In order to re-search for the route to the destination, the first disaster-related information, the second disaster-related information, and the weather information may be used.

The route setting criterion is described specifically. First, if the type of special report is tsunami, the server may re-search for a route to a destination by avoiding a coast road. Furthermore, if the type of special report is flood, the server may re-search for a route to a destination by avoiding a lowland flooding area. If the type of special report is typhoon, the server may re-search for a route to a destination by avoiding a typhoon entry/exit route. If the type of special report is an earthquake, the server may re-search for a route to a destination by avoiding an area having a danger of collapse.

Furthermore, alternatively, if the type of special report is heavy snow, the server may re-search for a route to a destination by taking a current/expected snowfall into consideration. If the type of special report is a forest fire, the server may re-search for a route to a destination by taking into consideration a current/expected wind direction.

The route setting criteria may be applied to a case where a route to a shelter is searched for identically/similarly in addition to the case where a route to a destination is searched for.

The setting criteria are merely examples, and the present invention is not limited to the examples. That is, it is evident that there may be other criteria, that is, criteria for route setting.

The pieces of information, such as the special weather report information, the nearby shelter location information, and the destination route re-search information included in the refuge information, may be displayed on a navigator screen included in the vehicle.

Specifically, the pieces of information included in the preparation information may be visualized and displayed on a partial screen of the navigator included in the vehicle.

For example, the existing destination route guidance may be displayed on a partial screen of the navigator, and the special weather report information or the shelter location information may be displayed on the remaining some screen. In this case, the shelter location information is optional information and may be displayed on a partial screen of the navigator based on a vehicle passenger's option.

In contrast, if the server determines that the type of special report is a special report that requires shelter guidance as a result of the determination of whether the type of special report is a special report that requires shelter guidance, the server determines whether the current location of the vehicle belongs to an alert area (S1431).

In this case, the server may determine whether the current location of the vehicle belongs to the alert area using location information periodically received from the vehicle.

If the server determines that the location of the vehicle does not belong to the alert area as a result of the determination of whether the current location of the vehicle belongs to the alert area, the server may generate refuge information and transmit the refuge information to the vehicle (S1442).

The refuge information may include nearby shelter location information and destination route re-search information. In this case, the server may transmit information on the location of a nearby shelter to the vehicle based on the second disaster-related information received from the second server.

Furthermore, the server may re-search for a route to the destination based on a route setting criterion differently set based on the type of special report.

In order to search for the route to the destination again, the first disaster-related information, the second disaster-related information, and the weather information may be used.

The route setting criterion is described specifically. First, if the type of special report is tsunami, the server may re-search for a route to a destination by avoiding a coast road. Furthermore, if the type of special report is flood, the server may re-search for a route to a destination by avoiding a lowland flooding area. If the type of special report is a typhoon, the server may re-search for a route to a destination by avoiding a typhoon entry/exit route. If the type of special report is an earthquake, the server may re-search for a route to a destination by avoiding an area having a danger of collapse.

The setting criteria are merely examples, and the present invention is not limited to the above examples. That is, it is evident that there may be other criteria, that is, criterions for route setting.

The nearby shelter location information and the destination route re-search information included in the refuge information may be displayed on a navigator screen included in the vehicle.

Specifically, the pieces of information in the preparation information may be visualized, and may be displayed on a partial screen of the navigator included in the vehicle that has received the refuge information.

For example, the existing destination route guidance may be displayed on a partial screen of the navigator, and the shelter location information may be displayed on the remaining some screen.

In contrast, if the server determines that the current location of the vehicle belongs to the alert area as a result of the determination of whether the current location of the vehicle belongs to the alert area, the server shows/re-searches for a nearby shelter route (S1441).

The server may transmit, to the vehicle, refuge information including information related to the guided/re-retrieved nearby shelter route.

In the route guidance/re-search process, the above-described route setting criteria may be applied.

In this case, shelter route guidance may be displayed on a partial screen of the navigator included in the vehicle that has received the refuge information.

Specifically, the nearby shelter route may be visualized, and may be displayed on a partial screen of the navigator included in the vehicle.

For example, the existing destination route guidance may be displayed on a partial screen of the navigator, and the nearby shelter route guidance may be displayed on the remaining some screen.

The determination procedure 1 may be completed by fully performing the above process. Furthermore, the determination procedure 1 may be repeatedly performed.

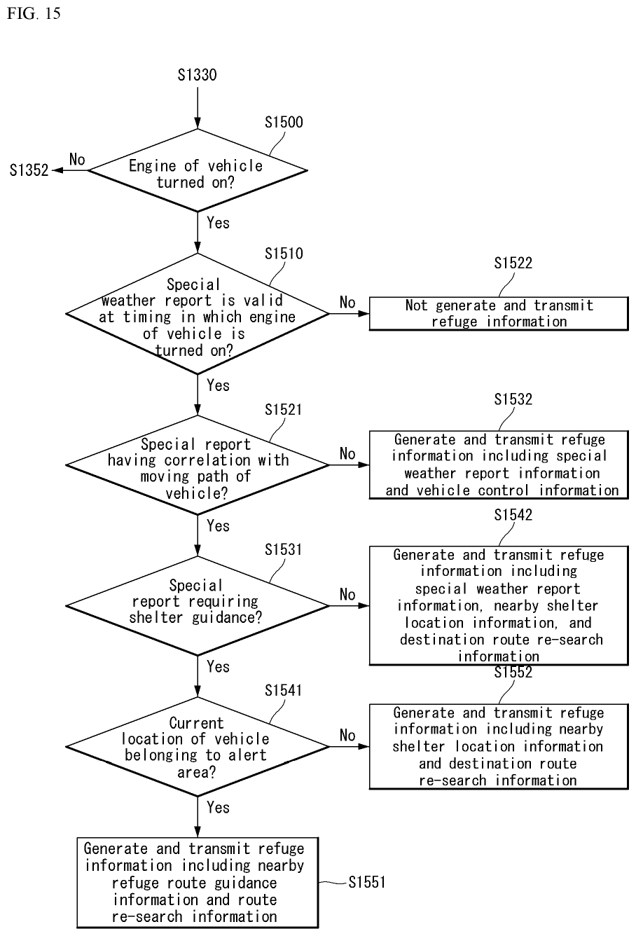

FIG. 15 is a flowchart of a method of providing disaster refuge information for an autonomous vehicle according to an embodiment of the present invention.

FIG. 15 shows a process performed in the determination procedure 2 specifically.

The determination procedure 2 is performed if it is determined that the engine of the vehicle is turned off as a result of the determining whether the engine of the vehicle has been turned on (S1500).

The server determines whether an issued special weather report is valid at timing in which the engine of the vehicle is turned on (S1510).

The server may determine whether an issued special weather report is valid at timing in which the engine of the vehicle is started using first disaster-related information.

More specifically, as described above, the server may periodically receive the first disaster-related information by periodically transmitting a request for the first disaster-related information to the first server.

Accordingly, the server may determine whether an issued special weather report is valid at timing in which the engine of the vehicle is turned on based on the last received first disaster-related information.

If the server determines that the issued special weather report is not valid at corresponding timing as a result of the determination of whether the issued special weather report is valid at the timing in which the engine of the vehicle is turned on, the server may not generate refuge information and may not transmit refuge information to the vehicle.

In this case, the navigator included in the vehicle that has not received refuge information may display a screen not related to refuge information.

The screen not related to refuge information means a common screen of the navigator related to route guidance. That is, the screen may be the existing home screen in a normal state not a disaster situation.

If the server determines that the issued special weather report is valid at the timing in which the engine of the vehicle is turned on as a result of the determination of whether the issued special weather report is valid at the timing in which the engine of the vehicle is turned, S1521 to S1541 are performed.

The contents and results of determinations in S1521 to S1541 of FIG. 15 are the same as those of S1422 to S1442 of FIG. 14, and thus a detailed description thereof is omitted.

Differences between operations performed by the server illustrated in FIG. 15 and the operations performed by the server illustrated in FIG. 14 are described.

First, the first difference is described.

S1521 to S1541 performed in FIG. 15 are performed by the server if the engine of the vehicle that has been turned off is turned on. In contrast, S1411 to S1431 performed in FIG. 14 are performed if the vehicle is driving.

Next, the second difference is described.

In S1521 to S1541 of FIG. 15, refuge information transmitted by the server is visualized in the navigator included in the vehicle that has received the refuge information, and is displayed on the entire screen of the navigator.

In contrast, in S1411 to S1431 of FIG. 14, refuge information transmitted by the server is visualized in the navigator included in the vehicle that has received the refuge information, and is displayed on a partial screen of the navigator.

More specifically, in the situation illustrated in FIG. 14, the entire screen of the navigator included in the vehicle is divided into one or more screens. The refuge information is displayed on one of the divided screens of the entire screen of the navigator.

That is, in the situation illustrated in FIG. 14, the refuge information is displayed on a screen of the navigator of a vehicle that is being driven. Accordingly, a navigator screen is divided into a screen on which the existing destination route guidance is displayed and a screen on which visualized refuge information is displayed.

A method of visualizing refuge information and displaying it on a navigator screen included in the vehicle is described more specifically later.

The pieces of information included in refuge information may be different depending on a specific criterion, and may be classified into three cases.

The three cases include a case where shelter guidance information and route resetting information are included in refuge information (Case 1), a case where disaster situation information and route resetting information are included in refuge information (Case 2), and a case where disaster situation information and vehicle control information included in refuge information (Case 3).

Hereinafter, (Case 1) to (Case 3) are described in detail in order from (Case 1) to (Case 3).

First, (Case 1) corresponds to a case where the server determines that the type of special weather report is associated with the moving route of a vehicle and requires shelter guidance as a result of a determination of determination contents for generating refuge information.

Furthermore, if the type of special weather report requires shelter guidance, whether to transmit information on the location of a shelter or route guidance information for the shelter is determined depending on whether the current location of a vehicle belongs to an alert area.

In summary, if it is determined that the type of special weather report is associated with the moving route of the vehicle and requires shelter guidance, if the current location of the vehicle belongs to an alert area, refuge information includes route resetting information and shelter route guidance information.

Alternatively, if it is determined that the type of special weather report is associated with the moving route of the vehicle and requires shelter guidance, if the location of the vehicle does not belong to an alert area, refuge information includes route resetting information and shelter location information.

The pieces of information includes in the refuge information may be visualized and displayed on a screen of the navigator in the vehicle.

More specifically, if the vehicle is driving, the refuge information may be displayed on some of screens divided from the entire screen of the navigator.

That is, the existing destination route may be displayed on a divided screen positioned on the left of the entire screen. Other pieces of information included in the refuge information may be displayed on a divided screen positioned on the right of the entire screen.

The examples are merely examples, and there may be a method of displaying the existing destination route and refuge information in the navigator.

Alternatively, if the engine of the vehicle that is parked is turned on, the refuge information may be displayed on the entire screen of the navigator.

The type of special weather report corresponding to (Case 1) may include tsunami, flood, a typhoon and an earthquake.

The type of special weather report is merely an example, and the present invention is not limited to the examples.

That is, the type of special weather report corresponding to (Case 1) may be further present in addition to the above type.

Next, (Case 2) corresponds to a case where the server determines that the type of special weather report is associated with the moving route of a vehicle and does not require shelter guidance as a result of a determination of determination contents for generating refuge information.

That is, if it is determined that the type of special weather report is associated with the moving route of the vehicle and does not require shelter guidance, refuge information includes route resetting information and disaster situation information.

The disaster situation information includes the occurrence date and occurrence location of a disaster situation, the distance from the vehicle, and shelter location identification information.

The pieces of information included in the refuge information may be visualized and displayed on a navigator screen included in the vehicle.

More specifically, if the vehicle is driving, the refuge information may be displayed on some of screens divided from the entire screen of the navigator.

That is, the existing destination route may be displayed on a divided screen positioned on the left of the entire screen, and other pieces of information included in the refuge information may be displayed on a divided screen positioned on the right of the entire screen.

The example is merely an example, and there may be another method of displaying the existing destination route and the refuge information in the navigator.

Alternatively, if the engine of a parked vehicle is turned on, the refuge information may be displayed on the entire screen of the navigator.

In (Case 2), the shelter location identification information included in the disaster situation information may be displayed on a navigator screen based on a vehicle passenger's choice.

The type of special weather report corresponding to (Case 2) may include heavy snow and a forest fire.

The type of special weather report is merely an example, and the present invention is not limited to the example.

That is, in addition, there may be another type of special weather report corresponding to (Case 2).

Finally, (Case 3) corresponds to a case where the server determines that the type of special weather report is not associated with the moving route of a vehicle as a result of determining determination contents for generating refuge information.

That is, if it is determined that the type of special weather report is not associated with the moving route of the vehicle, refuge information includes vehicle control information and disaster situation information.

The disaster situation information may include the occurrence date and occurrence location of a disaster situation or behavioral know-how information of a vehicle passenger.

The pieces of information includes in the refuge information may be visualized and displayed on a navigator screen included in the vehicle.

More specifically, if the vehicle is driving, the refuge information may be displayed on some of screens divided from the entire screen of the navigator.

That is, the existing destination route may be displayed on a divided screen positioned on the left of the entire screen, and other pieces of information included in the refuge information may be displayed on a divided screen positioned on the right of the entire screen.

The example is merely an example, and there may another method of displaying the existing destination route and the refuge information in the navigator.

Alternatively, if the engine of a parked vehicle is turned on, the refuge information may be displayed on the entire screen of the navigator.

The type of special weather report corresponding to (Case 3) may include yellow dust and fine dust.

The type of special weather report is merely an example, and the present invention is not limited to the example.

That is, in addition, there may be another type of special weather report corresponding to (Case 3).

Additionally, the present invention provides an option in which a vehicle determines whether to receive additional information from the server based on the type of special report during driving after route re-search and then additional information is displayed on a navigator screen included in the vehicle when the additional information is received.

Specifically, if the vehicle does not select the reception of additional information, a navigator screen may display only a destination or a shelter route guidance screen.

Alternatively, if the vehicle selects the reception of additional information, the entire screen of a navigator may be divided, a partial screen may guide a destination or a shelter route, and the remaining partial screen may display the additional information.

The selection of the additional information may be performed by a passenger within the vehicle.

For example, a destination or shelter route guidance may be displayed on a partial screen positioned on the left of the entire screen. Furthermore, additional information may be displayed on a partial screen positioned on the right of the entire screen.

The type of special report in which the additional information reception option is provided may include tsunami, a forest fire, heavy snow, flood, a typhoon and an earthquake.

Information displayed in the navigator through additional information may be different based on the type of special report.

Specifically, if the type of special report is tsunami, a forest fire or heavy snow, a CCTV screen monitoring an occurrence area is provided and displayed on a navigator screen.

Furthermore, if the type of special report is flood, a CCTV screen on which the flooding state of a surrounding landmark in an occurrence place, such as a bridge, can be checked is provided and displayed on a navigator screen.

Furthermore, if the type of special report is a typhoon, the expected progress route of the typhoon and an expected arrival time up to the current location of a vehicle are provided, and a zoom-out map is displayed on a navigator screen.

Finally, if the type of special report is an earthquake, the distance from the epicenter to a corresponding vehicle and a CCTV screen near an occurrence place are provided and displayed on a navigator screen.

The type of special weather report and the provided additional information are merely examples, and the present invention is not limited to the examples.

That is, in addition, there may be another type of special weather report in which additional information is provided.

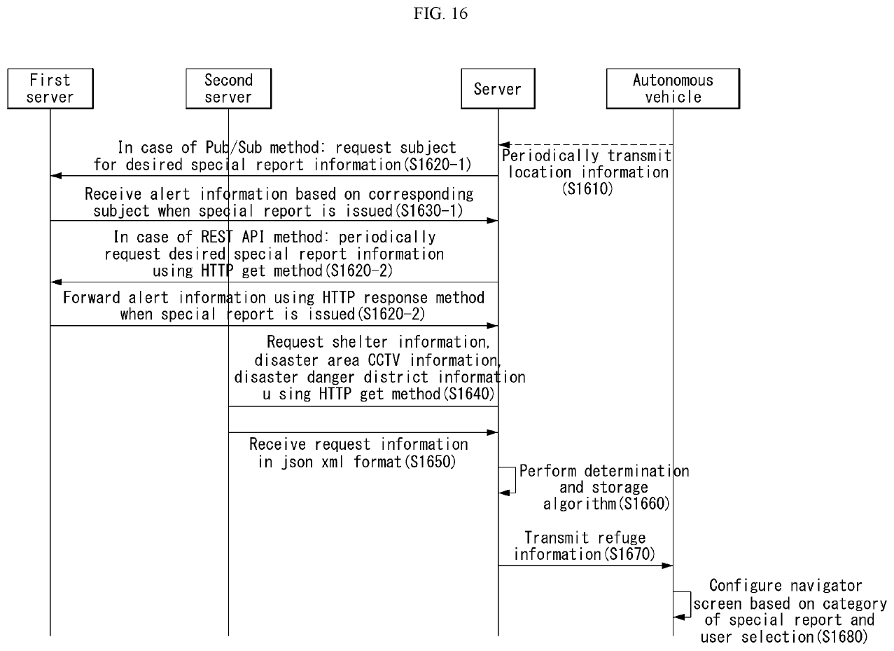

FIG. 16 is a flowchart of a system in which a method of providing vehicle refuge information in a disaster situation according to an embodiment of the present invention is performed.

FIG. 16 shows a server, a first server, a second server, and an autonomous vehicle included in a system in which a method of providing vehicle refuge information in a disaster situation is performed.

First, the server receives location information of the vehicle from the vehicle (S1610).

The location information may be GPS information of the vehicle.

Furthermore, the server may receive the location information periodically from the vehicle.

First, the server requests information related to a special weather report (first disaster-related information) from the first server (S1620-1, S1620-2).

The first server may be a weather center server.

The information related to the special weather report may include special weather report issue information issued by the first server.

The server received, from the first server, the information related to the special weather report (S1630-1, S1630-2).

A method of requesting information related to a special weather report and receiving it may include two types.

Specifically, there are a publish (Pub)/subscribe (Sub) method (S1620-1, S1630-1) and a representational state transfer (REST) application program interface (API) method (S1620-2, S1630-2).

The server requests, from the second server, shelter information, disaster area CCTV information, or disaster danger district information using an HTTP get method through an Open API (S1640).

The second server may be a public data portal server.

The shelter information, disaster area CCTV information, and disaster danger district information may be included in second disaster-related information.

Next, the server receives the shelter information, disaster area CCTV information, or disaster danger district information from the second server (S1650).

The pieces of information may have a JavaScript Object Notation (json)/eXtensible Markup Language (xml) format.

Next, the server performs an algorithm in order to provide the vehicle with information (or refuge information) for refuge from a disaster situation (S1660).

In this case, the server determines whether the type of special report is associated with a route, whether shelter guidance is necessary, and whether the current location of the vehicle belongs to an alert area based on the algorithm.

Furthermore, second server information may be stored for a vehicle whose engine has been turned off. The stored second server information may be maintained until an alert is released.

Refuge information is generated as a result of the execution of the algorithm.

Next, the server transmits refuge information to the vehicle based on a result of the execution of the algorithm (S1670).

The refuge information may include information necessary to configure a navigator screen and route resetting information.

Finally, the refuge information received from the server is visualized and displayed on a navigator screen included in the vehicle (S1680).

More specifically, if the vehicle is driving, the refuge information may be displayed on some of screens divided from the entire screen of the navigator.

That is, the existing destination route may be displayed on a divided screen positioned on the left of the entire screen, and other pieces of information included in the refuge information may be displayed on a divided screen positioned on the right of the entire screen.

The example is merely an example, and there may be another method of displaying the existing destination route and the refuge information in the navigator.

Alternatively, if the engine of a parked vehicle is turned on, the refuge information may be displayed on the entire screen of the navigator.

The sequence of the operations is not fixed, and the sequence of each operation may be changed.

Examples in which the method of providing vehicle refuge information in a disaster situation may be applied to various disaster situations are described below.

More specifically, a case where a tsunami alert is issued while a vehicle drives (Case 1), a case where a forest fire occurs while a vehicle drives (Case 2), and a case where a tornado alert is issued while a vehicle is parked (Case 3) are described.

Other disaster situations may be present in addition to the disaster situations in the examples, and the present invention is not limited to the examples.

Hereinafter, a first server may be a weather center server, and a second server may be a public data portal.

(Case 1)

(Case 1) is an example corresponding to a case where a tsunami alert will be issued while a vehicle drives.

In (Case 1), it is assumed that the vehicle is in the driving state and the location of the vehicle belongs to an alert issue area.

Furthermore, the vehicle is equipped with a navigator for visualizing and displaying refuge information received from a server.

Furthermore, it is assumed that tsunami corresponds to a disaster that requires route resetting and shelter guidance up to the existing destination in view of the type (characteristic) of disaster.

The server receives first disaster-related information from the first server using the REST API method.

The first disaster-related information may include a tsunami alert.

The server receives second disaster-related information through the Open API method from the second server.

The second disaster-related information may include shelter information, disaster area CCTV information, disaster danger district information, etc.

Next, the server determines whether the type of special weather report requires route resetting up to a destination based on the first disaster-related information.

In this case, the server determines that tsunami requires route resetting because tsunami corresponds to a disaster situation that requires route resetting.

Next, the server determines whether the type of special weather report requires shelter route guidance based on the first disaster-related information.

In this case, the server determines that the type of special weather report requires shelter route guidance because tsunami corresponds to a disaster situation that requires shelter route guidance.

Next, the server determines whether the current location of the vehicle belongs to an alert issue area.

In this case, the server may identify the location of the vehicle based on location information of the vehicle periodically transmitted from the vehicle to the server.

In this case, the server determines that the location of the vehicle belongs to the alert issue area because the vehicle belongs to a tsunami alert issue area.

Next, the server transmits first refuge information to the vehicle.

The refuge information may be generated based on the first disaster-related information, the second disaster-related information, and the location information of the vehicle.

Furthermore, the first refuge information may include a route to a destination, which is obtained by re-search by avoiding a coast road and a lowland flooding area.

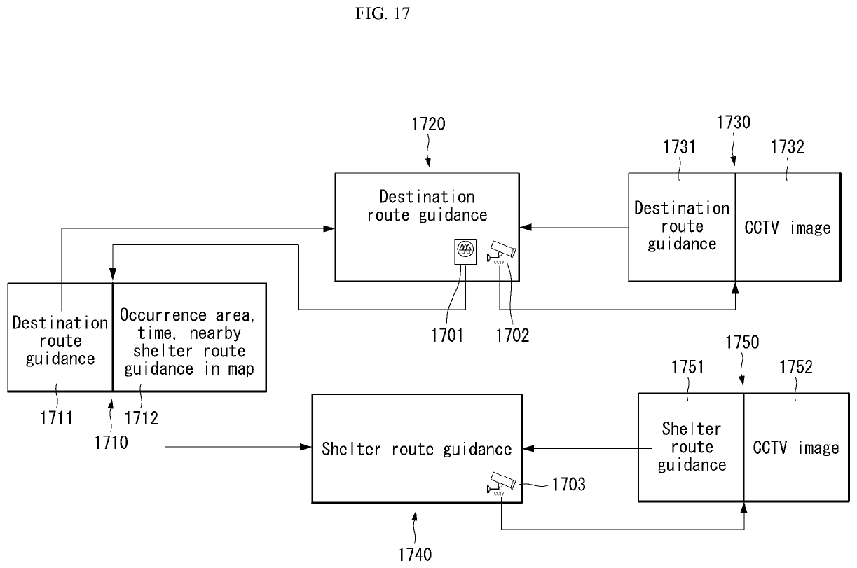

FIG. 17 is a diagram showing an example of a navigator screen provided in a vehicle in a method of providing disaster refuge information for an autonomous vehicle according to an embodiment of the present invention.

FIG. 17 specifically shows whether refuge information is displayed on a navigator screen included in the vehicle using which method in (Case 1).

As shown in FIG. 17, the vehicle divides a navigator screen and displays reset route guidance on the left (1711).

The example in which the screen of the navigator is divided and the reset route guidance is displayed on the left is merely an example, and the present invention is not limited thereto.

That is, the reset route guidance may be positioned at a different place other than the left of the navigator screen. In addition, it is evident that the reset route guidance may be displayed on a navigator screen using various methods.

Next, the server transmits second refuge information to the vehicle.

The refuge information may be generated based on first disaster-related information, second disaster-related information, and location information of the vehicle.

Furthermore, the second refuge information may include a route to a shelter in the highland that avoids a coast road and a lowland flooding area.

As shown in FIG. 17, the vehicle displays route guidance to the shelter on a screen on the right of the navigator (1712).

The example in which the screen of the navigator is divided and route guidance to the shelter is displayed on the right is merely an example, and the present invention is not limited thereto.

That is, the route guidance to the shelter may be positioned at a different place other than the right of the navigator screen. In addition, it is evident that the route guidance may be displayed on a navigator screen using various methods.

When a vehicle passenger touches the left destination route guidance screen 1711 twice, the corresponding screen is expanded to a full screen (1720).

The example in which when the left destination route guidance screen is touched twice, the corresponding screen is expanded to a full screen is merely an example, and the present invention is not limited thereto.

That is, the destination route guidance screen may be positioned at a different place other than the left of the navigator screen. The number of times that the destination route guidance screen is touched may be a different number other than two times.

Furthermore, when the vehicle passenger touches the right shelter route guidance screen touches, the corresponding screen is expanded to a full screen (1740).

An example in which when the right shelter route guidance screen is touched twice, the corresponding screen is expanded to a full screen is merely an example, and the present invention is not limited thereto.

That is, the shelter route guidance screen may be positioned at a different place other than the right of the navigator screen. The number of times that the shelter route guidance screen is touched twice may be a different number other than two times.

Next, the server transmits, to the vehicle, image URL information of public CCTV positioned at the coast of a tsunami occurrence area.

The image URL information of the public CCTV positioned at the coast of the tsunami occurrence area may be included in the second disaster-related information.

As another example of a navigator screen operation by a manipulation of a vehicle passenger, when the vehicle passenger selects a CCTV icon 1701, a CCTV image is displayed on the right of the navigator (1730).

The example in which when the passenger selects the CCTV icon, a CCTV image is displayed on the right is merely an example, and the present invention is not limited thereto.

That is, the CCTV image may be positioned at a different place other than the right of the navigator screen. In addition, it is evident that the CCTV image may be displayed on a navigator screen using various methods.

As another example of a navigator screen operation by a manipulation of a vehicle passenger, when the vehicle passenger selects a CCTV icon 1703, a CCTV image is displayed on the right of the navigator (1750).

The example in which when the passenger selects the CCTV icon, a CCTV image is displayed on the right is merely an example, and the present invention is not limited thereto.

That is, the CCTV image may be positioned at a different place other than the right of the navigator screen. In addition, it is evident that the CCTV image may be displayed on a navigator screen using various methods.

As another example of a navigator screen operation by a manipulation of a vehicle passenger, when the vehicle passenger touches a left destination route guidance screen 1731 twice, the corresponding screen is expanded to a full screen (1720).

The example in which when the left destination route guidance screen is touched twice, the corresponding screen is expanded to a full screen is merely an example, and the present invention is not limited thereto.

That is, the destination route guidance screen may be positioned at a different place other than the left of the navigator screen. The number of times that the destination route guidance screen is touched twice may be a different number other than two times.

As another example of a navigator screen operation by a manipulation of a vehicle passenger, when the vehicle passenger touches a left shelter route screen 1751 twice, the corresponding screen is expanded to a full screen (1740).

The example in which when the left shelter route guidance screen is touched twice, the corresponding screen is expanded to a full screen is merely an example, and the present invention is not limited thereto.

That is, the shelter route guidance screen may be positioned at a different place other than the left of the navigator screen. The number of times that the icon is touched twice may be a different number other than two times.

(Case 2)

(Case 2) is an example corresponding to a case where a forest fire will occur while a vehicle drives.

In (Case 2), it is assumed that the vehicle is in the driving state and the location of the vehicle belongs to an alert issue area.

Furthermore, the vehicle is equipped with a navigator for visualizing and displaying refuge information received from a server.

Furthermore, it is assumed that the forest fire corresponds to a disaster that requires route resetting up to a destination in view of the type (characteristic) of disaster, but does not require shelter guidance.

First, the server receives first disaster-related information from the first server using the REST API method.

The first disaster-related information may include a forest fire alert.

Next, the server receives second disaster-related information from the second server using the Open API method.

The second disaster-related information may include shelter information, disaster area CCTV information, disaster danger district information, etc.

Next, the server identifies whether the type of special weather report requires route resetting up to the destination based on the first disaster-related information.

In this case, the server determines that the type of special weather report does not require route resetting because the forest fire corresponds to a disaster situation that does not require route resetting.

Next, the server identifies whether the type of special weather report requires shelter route guidance based on the first disaster-related information.

In this case, the server determines that the type of special weather report requires shelter route guidance because the forest fire corresponds to a disaster situation that requires shelter route guidance.

Next, the server identifies whether the current location of the vehicle belongs to an alert issue area.

In this case, the server may identify the location of the vehicle based on location information of the vehicle periodically transmitted from the vehicle to the server.

In this case, the server determines that the location of the vehicle belongs to the alert issue area because the forest fire belongs to the alert issue area.

Next, the server receives weather information from the first server.

The weather information may include the current direction of wind, a forest fire area, rainfall information, the expected direction of wind, a forest fire area, and rainfall information.

Next, the server transmits refuge information to the vehicle.

The refuge information may be generated based on the first disaster-related information, the second disaster-related information, the location information of the vehicle, and the weather information.

Furthermore, the refuge information may include a route to a re-retrieved destination.

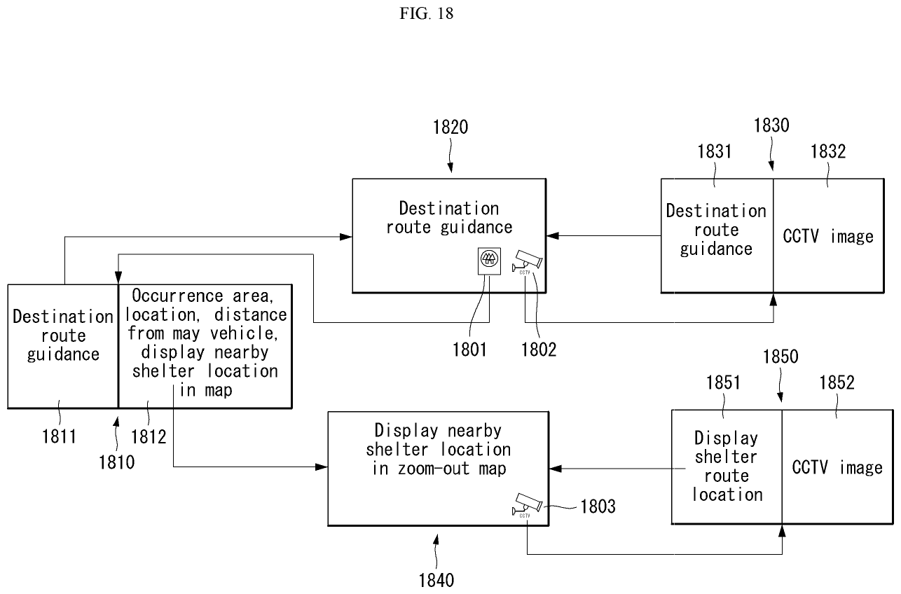

FIG. 18 is a diagram showing another example of a navigator screen provided in a vehicle in a method of providing disaster refuge information for an autonomous vehicle according to an embodiment of the present invention.

FIG. 18 specifically shows whether refuge information is displayed on a navigator screen included in a vehicle according to which method in (Case 2).

As shown in FIG. 18, the vehicle divides a navigator screen and shows a reset route on the left (1811).

The example in which the screen of the navigator is divided and the reset route is displayed on the left is merely an example, and the present invention is not limited thereto.

That is, the reset route may be positioned at a different place other than the left of the navigator screen. In addition, it is evident that the reset route may be displayed on a navigator screen using various methods.

Furthermore, as shown in FIG. 18, the vehicle divides the navigator screen and shows the location of a nearby shelter on the right (1812)

The example in which the screen of the navigator is divided and the location of a nearby shelter is shown on the right is merely an example, and the present invention is not limited thereto.

That is, the showing of the location of a nearby shelter may be positioned at a different place other than the right of the navigator screen. In addition, it is evident that the location of a nearby shelter may be displayed on a navigator screen using various methods.

When a vehicle passenger touches the left destination screen 1811 twice, the corresponding screen is expanded to a full screen (1820).

The example in which when the left destination route screen is touched twice, the corresponding screen is expanded to a full screen is merely an example, and the present invention is not limited thereto.

That is, the destination route screen may be positioned at a different place other than the left of the navigator screen. The number of times that the screen is touched may be a different number other than two times.

Alternatively, when the vehicle passenger touches the right nearby shelter location screen 1812 twice, the corresponding screen is expanded to a full screen (1840).

The example in which when the right shelter location screen is touched twice, the corresponding screen is expanded to a full screen is merely an example, and the present invention is not limited thereto.

That is, the nearby shelter location screen may be positioned at a different place other than the right of the navigator screen. The number of times that the screen is touched may be a different number other than two times.

Next, the server transmits, to the vehicle, coast public CCTV image URL information of a forest fire occurrence area.

The coast public CCTV image URL information of the forest fire occurrence area may be information included in second disaster-related information.

As another example of a navigator screen operation by a manipulation of a vehicle passenger, when the vehicle passenger selects a CCTV icon 1802, a CCTV image is displayed on the right of the navigator (1832).

The example in which when the passenger selects the CCTV icon, a CCTV image is displayed on the right is merely an example, and the present invention is not limited thereto.

That is, the CCTV image may be positioned at a different place other than the right of the navigator screen. In addition, it is evident that a CCTV image may be displayed on a navigator screen using various methods.

As another example of a navigator screen operation by a manipulation of a vehicle passenger, when the vehicle passenger selects a CCTV icon 1803, a CCTV image is displayed on the right of the navigator (1852).

The example in which when the passenger selects a CCTV icon, a CCTV image is displayed on the right is merely an example, and the present invention is not limited thereto.

That is, a CCTV image may be positioned at a different place other than the right of the navigator screen. In addition, it is evident that a CCTV image may be displayed on a navigator screen using various methods.

Alternatively, when the vehicle passenger touches a left destination route guidance screen 1831 twice, the corresponding screen is expanded to a full screen (1820).

The example in which when the left destination route guidance screen is touched twice, the corresponding screen is expanded to a full screen is merely an example, and the present invention is not limited thereto.

That is, the destination route guidance screen may be positioned at a different place other than the left of the navigator screen. The number of times that the destination route guidance screen is touched may be a different number other than two times.

Alternatively, when the vehicle passenger touches a left nearby shelter location screen 1851 touches, the corresponding screen is expanded to a full screen (1840).

The example in which when the left nearby shelter location screen is touched twice, the corresponding screen is expanded to a full screen is merely an example, and the present invention is not limited thereto.

That is, the nearby shelter location screen may be positioned at a different place other than the left of the navigator screen. The number of times that the nearby shelter location screen is touched may be a different number other than two times.

(Case 3)

(Case 3) is an example corresponding to a case where a tornado alert will be issued while a vehicle is parked.

In (Case 3), it is assumed that the vehicle is in the parking state and the location of the vehicle belongs to an alert issue area.

Furthermore, the vehicle is equipped with a navigator for visualizing and displaying refuge information received from a server.

Furthermore, it is assumed that a tornado corresponds to a disaster that requires shelter guidance in view of the type (characteristic) of disaster.

First, the server receives first disaster-related information from the first server using the REST API method.

The first disaster-related information may include a tornado alert.

Next, the server receives second disaster-related information from the second server using the Open API method.

The second disaster-related information may include shelter information, disaster area CCTV information, disaster danger district information, etc.

Next, the server stores the first disaster-related information and the second disaster-related information for the vehicle whose engine is turned off at corresponding timing.

In this case, the server may store the first disaster-related information and the second disaster-related information until the tornado alert is released.

That is, when the tornado alert is released, the server may delete the first disaster-related information and the second disaster-related information from the memory.

Next, the server identifies whether the type of special weather report requires shelter route guidance based on the first disaster-related information.

In this case, the server determines that the type of special weather report requires shelter route guidance because a tornado corresponds to a disaster situation that requires shelter route guidance.

Next, the server identifies whether the current location of the vehicle belongs to an alert issue area.

In this case, the server determines that the location of the vehicle belongs to the alert issue area because the vehicle belongs to the tornado alert issue area.

Next, the engine of the vehicle is turned on in order to move to a destination and/or a shelter.

Next, the server transmits refuge information to the vehicle.

The refuge information may be generated based on the first disaster-related information and the second disaster-related information.

Furthermore, the refuge information may include a route to the shelter by avoiding a lowland flooding area and an expected tornado progress route.

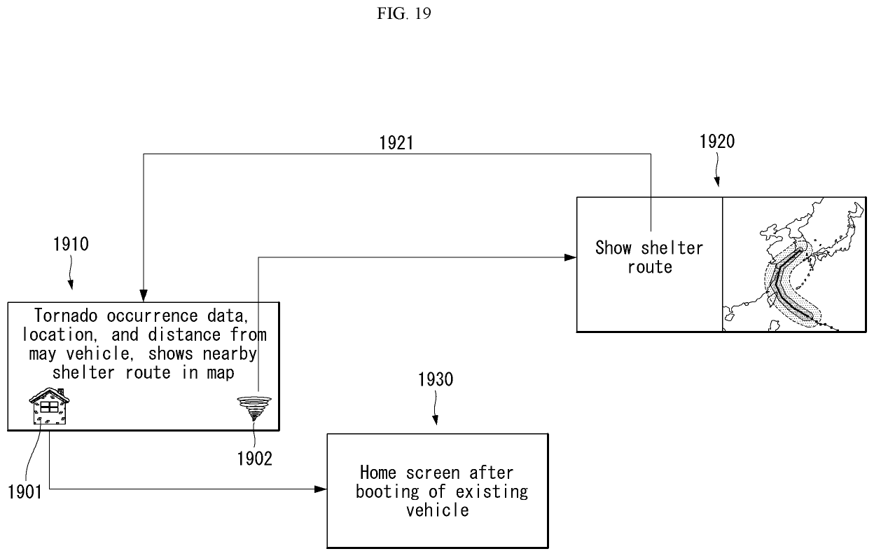

FIG. 19 is a diagram showing another example of a navigator screen provided in a vehicle in a method of providing disaster refuge information for an autonomous vehicle according to an embodiment of the present invention.

FIG. 19 specifically shows that refuge information is displayed on a navigator screen included in a vehicle according to which method in (Case 3).

The vehicle shows a route, set up to a shelter, on the entire screen of the navigator, as shown in 1910 of FIG. 19.

That is, if an alert is issued when the engine of the vehicle is turned on in a parking state, the navigator included in the vehicle displays, on the entire screen, visualized information of refuge information received from a server.

As an example of a navigator screen operation by a manipulation of the vehicle passenger, when the vehicle passenger selects a home icon 1901 displayed on the navigator screen, the screen moves to the first screen after the booting of the existing vehicle, as shown in 1930 of FIG. 19.

“After the booting of the existing vehicle” means that an alert has not been issued when the engine of the vehicle is turned on in a parking state.

As another example of a navigator screen operation by a manipulation of a vehicle passenger, when the vehicle passenger selects a tornado icon 1912 displayed on the navigator screen, some of the screen of the navigator shows an expected progress route of the tornado and the time when the tornado will be closest to my vehicle, as shown in 1920 of FIG. 19.

Specifically, the navigator may divide a screen and display the expected progress route of a tornado and the time when my vehicle is closest to the tornado on the right.

The example in which the screen of a navigator is divided and the expected progress route of a tornado and the time when my vehicle is closest to the tornado are displayed on the right is merely an example, and the present invention is not limited thereto.

That is, information on the expected progress route of a tornado and the time when my vehicle is closest to the tornado may be positioned at a different place other than the right of the navigator screen. In addition, it is evident that the information may be displayed on a navigator screen using various methods.

As another example of a navigator screen operation by a manipulation of the vehicle passenger, when a vehicle passenger touches the left shelter route guidance screen displayed on the navigator screen twice (1921), the corresponding screen is expanded to a full screen (1910).

The example in which when the left shelter route guidance icon is touched twice, the corresponding screen is expanded to a full screen is merely an example, and the present invention is not limited thereto.

That is, the shelter route guidance screen may be positioned at a different place other than the left of the navigator screen. The number of times that the icon is touched twice may be a different number other than two times.

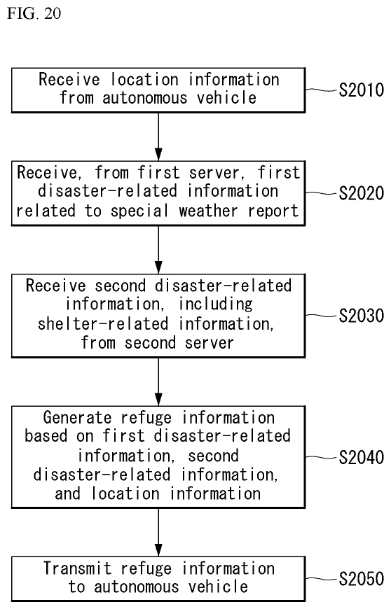

FIG. 20 is a flowchart of a method of providing disaster refuge information for an autonomous vehicle according to an embodiment of the present invention.

FIG. 20 is a diagram showing an example of an operation performed in a server to which the method of providing disaster refuge information for an autonomous vehicle described through FIGS. 1 to 19 of the present invention may be applied.

The server receives location information from an autonomous vehicle (S2010).

Next, the server receives, from a first server, first disaster-related information related to a special weather report (S2020).

Next, the server receives second disaster-related information, including shelter-related information, from a second server (S2030).

Next, the server generates refuge information based on the first disaster-related information, the second disaster-related information, and the location information (S2040).

Next, the server transmits the refuge information to the autonomous vehicle (S2050).

In this case, the refuge information includes at least one of shelter guidance information, vehicle control information or route resetting information.

Meanwhile, a vehicle may interact with at least one robot. The robot may be an autonomous mobile robot (AMR). The AMR can move freely because it can move autonomously, and can drive by avoiding an obstacle because it is equipped with a plurality of sensors for avoiding an obstacle while driving. The AMR may be a fly type robot (e.g., drone) having a flying device. The AMR may be a wheel type robot having at least one wheel and moving through the rotation of the wheel. The AMR may be a leg type robot having at least one leg and moving using the leg.

The robot may function as a device that supplements a vehicle user's convenience. For example, the robot may perform a function for moving a load on a vehicle up to the final destination of a user. For example, the robot may perform a function for showing a road to the final destination with respect to a user who got off a vehicle. For example, the robot may perform a function for transporting a user who got off a vehicle up to the final destination.

At least one electronic device included in a vehicle may perform communication with the robot through a communication device.

At least one electronic device included in a vehicle may provide the robot with data processed by the at least one electronic device of the vehicle. For example, the at least one electronic device included in the vehicle may provide the robot with at least one of object data, HD map data, vehicle state data, vehicle location data or driving plan data.

At least one electronic device included in a vehicle may receive, from the robot, data processed by the robot. At least one electronic device included in a vehicle may receive at least any one of sensing data, object data, robot state data, or robot location data generated by the robot and the moving plan data of the robot.

At least one electronic device included in a vehicle may generate a control signal based on data received from the robot. For example, at least one electronic device included in a vehicle may compare information on an object generated by an object detection device with information on an object generated by the robot, and may generate a control signal based on a result of the comparison. At least one electronic device included in a vehicle may generate a control signal so that interference does not occur between the moving route of the vehicle and the moving route of the robot.

At least one electronic device included in a vehicle may include a software module or hardware module implementing artificial intelligence (AI) (hereinafter referred to as an “artificial intelligence module”). At least one electronic device included in a vehicle may input obtained data to the artificial intelligence module, and may use data output by the artificial intelligence module.

The artificial intelligence module may perform machine learning on input data using at least one artificial neural network (ANN). The artificial intelligence module may output driving plan data through the machine learning for the input data.

At least one electronic device included in a vehicle may generate a control signal based on data output by the artificial intelligence module.

In an embodiment, at least one electronic device included in a vehicle may receive, from an external device, data processed by artificial intelligence through a communication device. At least one electronic device included in a vehicle may generate a control signal based on data processed by artificial intelligence.

In the above-described embodiments, the elements and characteristics of the present invention have been combined in a specific form. Each of the elements or characteristics may be considered to be optional unless otherwise described explicitly. Each of the elements or characteristics may be implemented in a form to be not combined with other elements or characteristics. Furthermore, some of the elements and/or the characteristics may be combined to form an embodiment of the present invention. The sequence of the operations described in the embodiments of the present invention may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present invention without departing from the spirit or scope of the invention described in the appended claims. For example, each component described in detail in embodiments can be modified. In addition, differences related to such modifications and applications should be interpreted as being included in the scope of the present invention defined by the appended claims.

Although description has been made focusing on examples in which the present invention is applied to automated vehicle & highway systems based on 5G (5 generation) system, the present invention is also applicable to various wireless communication systems and autonomous devices.

1. A method of providing disaster refuge information for an autonomous vehicle, the method comprising:
receiving location information from an autonomous vehicle;
receiving, from a first server, first disaster-related information related to a special weather report;
receiving, from a second server, second disaster-related information comprising shelter-related information;
generating refuge information based on the first disaster-related information, the second disaster-related information, and the location information; and
transmitting the refuge information to the autonomous vehicle,
wherein the refuge information comprises at least one of shelter guidance information, vehicle control information or route resetting information.

2. The method of claim 1,
wherein generating refuge information comprises:
determining whether an engine of the autonomous vehicle is turned on; and
performing one of a first determination procedure or a second determination procedure depending on whether the engine of the autonomous vehicle is turned on.

3. The method of claim 2,
wherein the first determination procedure is performed if the engine of the autonomous vehicle is turned on, and
wherein the first determination procedure comprises:
determining whether the first disaster-related information has a relevance to a moving route of the autonomous vehicle;
determining whether shelter guidance is necessary based on the first disaster-related information; and
determining whether the autonomous vehicle now belongs to a disaster alert area based on the location information.

4. The method of claim 2,
wherein the second determination procedure is performed if the engine of the autonomous vehicle is not turned on, and
wherein the second determination procedure comprises determining whether the first disaster-related information is valid at timing in which the engine of the autonomous vehicle is turned on.

5. The method of claim 4,
wherein the autonomous vehicle is equipped with a navigator, and
wherein a screen of the navigator displays a common screen of the navigator related to route guidance if the first disaster-related information is not valid at the timing in which the engine of the autonomous vehicle is turned on.

6. The method of claim 4,
wherein if the first disaster-related information is valid at the timing in which the engine of the autonomous vehicle is turned on, the second determination procedure further comprises:
determining whether the first disaster-related information has a relevance to the moving route of the autonomous vehicle;
determining whether shelter guidance is necessary based on the first disaster-related information; and
determining whether the autonomous vehicle now belongs to the disaster alert area based on the location information.

7. The method of claim 1,
wherein the first disaster-related information is special weather report issue information.

8. The method of claim 1,
wherein the second disaster-related information comprises at least one of shelter information, disaster area CCTV information or disaster danger district information.

9. The method of claim 1, further comprising:
providing additional disaster-related information to the autonomous vehicle based on the first disaster-related information,
wherein whether to provide the additional disaster-related information is determined based of a choice of a passenger of the autonomous vehicle.

10. The method of claim 1,
wherein the location information is transmitted periodically by the autonomous vehicle.

11. The method of claim 1,
wherein receiving first disaster-related information comprises:
requesting, from the first server, the first disaster-related information necessary to provide specific disaster information to the vehicle; and
receiving the first disaster-related information from the first server if a special weather report is issued.

12. The method of claim 1,
wherein receiving first disaster-related information comprises:
periodically requesting the first disaster-related information from the first server; and
receiving the first disaster-related information from the first server if a special weather report is issued.

13. The method of claim 1,
wherein the first server comprises a weather center server,
wherein the second server comprises a public portal server, and
wherein receiving second disaster-related information comprises:
requesting the second disaster-related information from the second server; and
receiving the second disaster-related information from the second server.

14. The method of claim 1,
wherein the autonomous vehicle comprises a navigator, and
wherein at least one of the shelter guidance information, the vehicle control information or the route resetting information is displayed on a part or full screen of the navigator.

15. A method of providing disaster refuge information for an autonomous vehicle, the method comprising:
periodically transmitting location information to a first server; and
receiving refuge information from the first server,
wherein the refuge information is generated by the first server based on first disaster-related information related to a special weather report, second disaster-related information comprising shelter-related information, and location information,
wherein the refuge information comprises at least one of shelter guidance information, vehicle control information or route resetting information.

16. The method of claim 1, further comprising:
transmitting, to the autonomous vehicle, downlink control information (DCI) used to schedule the transmission of the refuge information,
wherein the refuge information is transmitted to the autonomous vehicle based on the DCI.

17. The method of claim 16, further comprising:
performing an initial access procedure with the autonomous vehicle based on a synchronization signal block (SSB),
wherein the refuge information is transmitted to the autonomous vehicle through a physical downlink shared channel (PDSCH), and
wherein the SSB and a dedicated demodulation-reference signal (DM-RS) of the PDSCH are QCLed with respect to a quasi co-location (QCL) type D.

18. An intelligent computing device controlling an autonomous vehicle and providing disaster refuge information for the autonomous vehicle, the intelligent computing device comprising:
a wireless communication unit;
a location information acquisition unit;
a processor; and
a memory comprising a command executable by the processor,
wherein the command enables location information of the vehicle to be transmitted to a first server through the wireless communication unit and enables refuge information to be received from the first server,
wherein the refuge information is generated by the first server based on first disaster-related information related to a special weather report, second disaster-related information comprising shelter-related information, and the location information, and
wherein the refuge information comprises at least one of shelter guidance information, vehicle control information or route resetting information.
